(19) United States
(12) Patent Application Publication
(10) Pub. No.: US 2025/0357968 A1
(43) Pub. Date: Nov. 20, 2025

(54) IN-VEHICLE RELAY APPARATUS, IN-VEHICLE COMMUNICATION SYSTEM, COMMUNICATION PROGRAM, AND COMMUNICATION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yuki SANO, Yokkaichi-shi, Mie (JP)

(21) Appl. No.: 17/597,994

(22) PCT Filed: Jul. 16, 2020
(86) PCT No.: PCT/JP2020/027634

§ 371 Date: Aug. 5, 2025

(30) Foreign Application Priority Data
Aug. 2, 2019 (JP) 2019-143160

(51) Int. Cl. H04B 3/36; H04L 9/40; H04L 12/46; H04L 67/12

(52) U.S. Cl. CPC H04B 3/36; H04L 12/46; H04L 63/1425; H04L 67/12

(57) ABSTRACT

An in-vehicle relay apparatus configured to reduce an adverse effect from an unauthorized apparatus being connected to a communication line in a vehicle. The in-vehicle relay apparatus is to be connected to a plurality of communication lines mounted in a vehicle, and relays transmission/reception of data between the communication lines. The in-vehicle relay apparatus includes a relay restricting unit restricting data transmitted by a communication apparatus newly connected to one communication line from being relayed to another communication line. A behavior analysis unit analyzes an operation performed by the communication apparatus, based on correspondence information between an input value that is input to the communication apparatus and an operation result of the communication apparatus in response to the input value. A restriction cancelling unit cancels relay restriction performed by the relay restricting unit, in accordance with a result of analysis performed by the behavior analysis unit.

### CROSS-REFERENCE TO RELATED APPLICATIONS

This application is the U.S. national stage of PCT/JP2020/027634 filed on Jul. 16, 2020, which claims priority of Japanese Patent Application No. JP 2019-143160 filed on Aug. 2, 2019, the contents of which are incorporated herein.

### TECHNICAL FIELD

The present disclosure relates to an in-vehicle relay apparatus, an in-vehicle communication system, a communication program, and a communication method for relaying transmission/reception of data between communication apparatuses mounted in a vehicle.

### BACKGROUND

Recent years have seen a trend of an increase in the number of ECUs (Electronic Control Units) mounted in a vehicle. Each ECU communicates with another ECU to transmit/receive information to/from the other ECU, and performs various types of processing. Therefore, as the number of ECUs in a vehicle increases, the number of communication lines in the vehicle that are provided for the ECUs to perform communication increases, leading to an increase in the weight of the vehicle and a decrease in the space in the vehicle in which the communication lines are arranged.

JP 2015-67187A describes a vehicle control system configured such that the inside of a vehicle is divided into a plurality of regions, and, in each of the regions, a plurality of function ECUs are connected to a relay ECU by a first network, and a plurality of relay ECUs are connected by a second network.

As the number of ECUs that are mounted in a vehicle increases and the functions of the ECUs are improved, the importance of communication between ECUs via a network in the vehicle and the importance of security of communication have been increasing. There is concern that, when an unauthorized apparatus is connected to a communication line in the vehicle that constitutes a network, this apparatus will perform unauthorized data transmission.

The present disclosure has been made in view of such circumstances, and has an object of providing an in-vehicle relay apparatus, an in-vehicle communication system, a communication program, and a communication method that can be expected to reduce the adverse effect of an unauthorized apparatus being connected to a communication line in a vehicle.

### SUMMARY

An in-vehicle relay apparatus according to an aspect of the present disclosure is an in-vehicle relay apparatus that is to be connected to a plurality of communication lines mounted in a vehicle, and relays transmission/reception of data between the communication lines, and includes: a relay restricting unit configured to restrict data that is transmitted by a communication apparatus newly connected to one communication line from being relayed to another communication line; a behavior analysis unit configured to analyze an operation performed by the communication apparatus, based on correspondence information between an input value that is input to the communication apparatus and an operation result of the communication apparatus in response to the input value; and a restriction cancelling unit configured to cancel relay restriction performed by the relay restricting unit, in accordance with a result of analysis performed by the behavior analysis unit.

The present application can be realized not only as an apparatus such as an in-vehicle relay apparatus that includes the above-described characteristic processing units, but also as a communication method that includes the above-described characteristic processing as steps, or a computer program for causing a computer to execute the steps. The present application can be realized as a semiconductor integrated circuit that realizes some or all of such apparatuses, or as another apparatus or system that includes such apparatuses.

### Advantageous Effects

According to the above aspects, it can be expected to reduce the adverse effect of an unauthorized apparatus being connected to a communication line in a vehicle.

### BRIEF DESCRIPTION OF DRAWINGS

FIG. 1 is a schematic diagram for describing an overview of an in-vehicle communication system according to an embodiment of the present disclosure.

FIG. 2 is a block diagram showing a configuration of a second relay apparatus according to the embodiment.

FIG. 3 is a block diagram showing a configuration of a first relay apparatus according to the embodiment.

FIG. 4 is a flowchart showing the procedure of processing that is performed by a second relay apparatus according to the embodiment.

FIG. 5 is a flowchart showing the procedure of behavior analysis processing that is performed by a second relay apparatus according to the embodiment.

FIG. 6 is a schematic diagram for describing an overview of authentication processing that is performed by an in-vehicle communication system according to the embodiment.

FIG. 7 is a flowchart showing the procedure of authentication processing that is performed by a second relay apparatus according to the embodiment.

FIG. 8 is a flowchart showing the procedure of processing that is performed by a first relay apparatus according to the embodiment.

FIG. 9 is a schematic diagram for describing an ECU authentication method that is performed by an in-vehicle communication system according to a second embodiment.

### DETAILED DESCRIPTION OF PREFERRED EMBODIMENTS

First, embodiments of the present disclosure will be listed and described. At least some of the embodiments to be described below may be suitably combined.

An in-vehicle relay apparatus according to one aspect of the present disclosure is an in-vehicle relay apparatus that is to be connected to a plurality of communication lines mounted in a vehicle, and relays transmission/reception of data between the communication lines, the in-vehicle relay apparatus including: a relay restricting unit configured to restrict data that is transmitted by a communication apparatus newly connected to one communication line from being relayed to another communication line; a behavior analysis unit configured to analyze an operation performed by the communication apparatus, based on correspondence information between an input value that is input to the communication apparatus and an operation result of the communication apparatus in response to the input value; and a restriction cancelling unit configured to cancel relay restriction performed by the relay restricting unit, in accordance with a result of analysis performed by the behavior analysis unit.

In this aspect, the in-vehicle relay apparatus that is to be connected to a plurality of communication lines and relays transmission/reception of data between the communication lines restricts data that is transmitted by a communication apparatus newly connected to one communication line from being relayed to another communication line. The in-vehicle relay apparatus analyzes an operation (behavior) of the newly connected communication apparatus based on correspondence information between an input value that is input to the communication apparatus and an operation result in response to this input value. If it is determined, as a result of the analysis, that the newly connected communication apparatus is an authorized apparatus, for example, the in-vehicle relay apparatus cancels the relay restriction, and relays data that is transmitted by this communication apparatus to another communication line. Accordingly, the in-vehicle relay apparatus can relay data that is transmitted by a communication apparatus that performs an authorized operation, and restrict relay of data that is transmitted by a communication apparatus that does not perform an authorized operation. Thus, the in-vehicle relay apparatus can prevent an adverse effect due to data that is transmitted by the communication apparatus that does not perform an authorized operation from extending to another communication line.

Preferably, the in-vehicle relay apparatus includes a correspondence information obtaining unit configured to obtain the correspondence information from an apparatus external to the vehicle, and a storage unit configured to store the correspondence information obtained by the correspondence information obtaining unit.

In this aspect, the in-vehicle relay apparatus obtains information for analyzing an operation from an apparatus external to the vehicle. Accordingly, the in-vehicle relay apparatus can obtain required information from the external apparatus and analyze the operation without storing a large amount of information in advance.

Preferably, the correspondence information includes information regarding an input value that is input to the communication apparatus and an expected value that is output by the communication apparatus in response to the input value, and the behavior analysis unit inputs the input value included in the correspondence information to the communication apparatus, obtains an output value of the communication apparatus output in response to the input value, and compares the obtained output value and the expected value included in the correspondence information.

In this aspect, information that is used for analyzing an operation includes information regarding an input value that is input to a communication apparatus, and an expected value of an output value that is output by the communication apparatus in response to this input value. The in-vehicle relay apparatus inputs an input value to a communication apparatus based on this information, and obtains an output value of the communication apparatus in response to this input. The in-vehicle relay apparatus compares the obtained output value with an expected value included in the information, and can determine whether or not an operation of this communication apparatus is authorized.

Preferably, the in-vehicle relay apparatus includes an authentication processing unit configured to perform authentication processing on the communication apparatus, and the restriction cancelling unit cancels relay restriction that is performed by the relay restricting unit, in accordance with a result of analysis performed by the behavior analysis unit and a result of authentication processing performed by the authentication processing unit.

In this aspect, authentication processing is performed between the in-vehicle relay apparatus and the communication apparatus. It is possible to adopt authentication processing that uses key information such as a public key or a private key. The in-vehicle relay apparatus cancels relay restriction of data that is transmitted by the communication apparatus, based on an analysis result and an authentication processing result. Accordingly, the in-vehicle relay apparatus relays data of a communication apparatus that performs an authorized operation and have been determined as being an authorized apparatus through authentication, making it possible to improve the reliability of data that is being relayed.

Preferably, the in-vehicle relay apparatus includes a relay processing unit configured to relay transmission/reception of data related to authentication processing between the communication apparatus newly connected to the one communication line and the communication apparatus connected to the other communication line, after relay restriction is canceled by the restriction cancelling unit.

In this aspect, after relay restriction of data that is transmitted by the communication apparatus is canceled, the in-vehicle relay apparatus relays data related to authentication processing that is performed between this communication apparatus connected to the one communication line and the communication apparatus connected to the other communication line. It is possible to improve the reliability of communication within the vehicle by enabling a plurality of apparatuses to perform authentication processing on the newly connected communication apparatus in this manner instead of only one in-vehicle relay apparatus performing authentication processing of the newly connected communication apparatus.

An in-vehicle communication system according to another aspect of the present disclosure includes a first in-vehicle relay apparatus mounted in a vehicle, a plurality of second in-vehicle relay apparatuses connected to the first in-vehicle relay apparatus via first communication lines, and communication apparatuses connected to the second in-vehicle relay apparatuses via second communication lines, the first in-vehicle relay apparatus relaying transmission/reception of data between the plurality of second in-vehicle relay apparatuses, and the second in-vehicle relay apparatuses relaying transmission/reception of data between the first in-vehicle relay apparatus and the communication apparatuses, whereby each second in-vehicle relay apparatus includes: a relay restricting unit configured to restrict data that is transmitted by a communication apparatus newly connected to the second communication line from being relayed to the first communication line, a behavior analysis unit configured to analyze an operation of the communication apparatus based on correspondence information between an input value that is input to the communication apparatus and an operation result of the communication apparatus in response to the input value, and a restriction cancelling unit configured to cancel relay restriction performed by the relay restricting unit, in accordance with a result of analysis performed by the behavior analysis unit.

In this aspect, similarly to aspect (1), it is possible to prevent an adverse effect due to data that is transmitted by a communication apparatus that does not perform an authorized operation from extending to another communication line.

Preferably, the second in-vehicle relay apparatus includes a relay processing unit configured to relay transmission/reception of data related to authentication processing between the communication apparatus newly connected to the second communication line and the first in-vehicle apparatus connected to the first communication line, after restriction of relay is canceled by the restriction cancelling unit, and the first in-vehicle relay apparatus includes an authentication processing unit configured to perform authentication processing on the communication apparatus newly connected to the second communication line, via the second in-vehicle relay apparatus.

In this aspect, similarly to aspect (5), it is possible to improve the reliability of communication within the vehicle.

A communication program according to another aspect of the present disclosure causes an in-vehicle relay apparatus that is to be connected to a plurality of communication lines mounted in a vehicle and relays transmission/reception of data between the communication lines to restrict data that is transmitted by a communication apparatus newly connected to one communication line from being relayed to another communication line, analyze an operation performed by the communication apparatus, based on correspondence information between an input value that is input to the communication apparatus and an operation result of the communication apparatus in response to the input value, and perform processing for cancelling restriction of relay in accordance with an analysis result.

In this aspect, similarly to aspect (1), it is possible to prevent an adverse effect from data that is transmitted by a communication apparatus that does not perform an authorized operation, from covering another communication line.

In a communication method according to another aspect of the present disclosure, an in-vehicle relay apparatus that relays transmission/reception of data between a plurality of communication lines mounted in a vehicle restricts data that is transmitted by a communication apparatus newly connected to one communication line from being relayed to another communication line, analyzes an operation of the communication apparatus based on correspondence information between an input value that is input to the communication apparatus and an operation result of the communication apparatus in response to the input value, and cancels restriction of relay in accordance with an analysis result.

In this aspect, similarly to aspect (1), it is possible to prevent an adverse effect due to data that is transmitted by a communication apparatus that does not perform an authorized operation from extending to another communication line. Specific examples of an in-vehicle communication system according to embodiments of the present disclosure will be described below with reference to the drawings. The present disclosure is not limited to illustrations of these, but is indicated by the claims, and all changes that come within the meaning and range of equivalency of the claims are intended to be embraced therein.

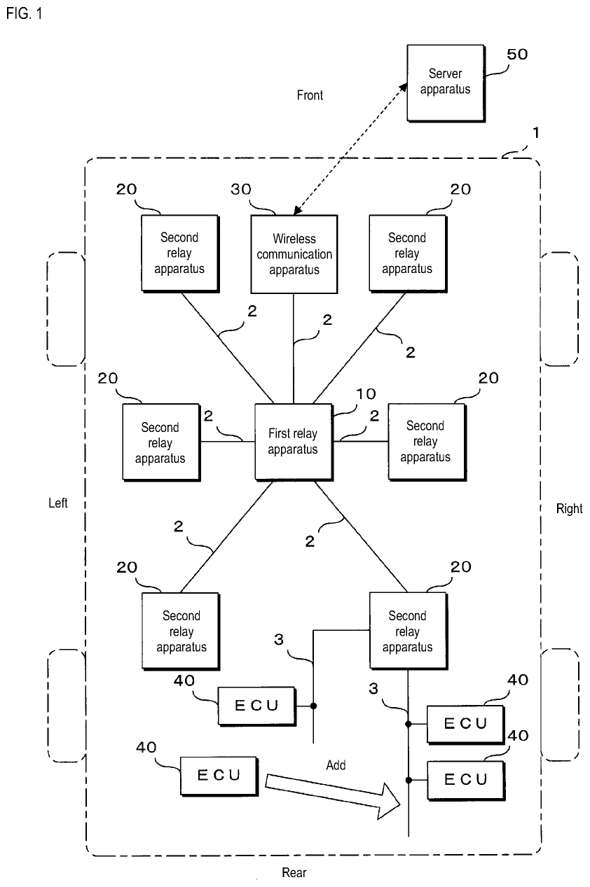

System Overview FIG. 1 is a schematic diagram for describing an overview of an in-vehicle communication system according to an embodiment. The in-vehicle communication system according to the embodiment is constituted by a first relay apparatus 10 mounted in a vehicle 1, a plurality of second relay apparatuses 20, a wireless communication apparatus 30, and a plurality of ECUs 40. The up-down direction in FIG. 1 corresponds to the front-rear direction of the vehicle 1, and the right-left direction in FIG. 1 corresponds to the right-left direction of the vehicle 1. The number of apparatuses included in the in-vehicle communication system, the number of communication lines, the connection form of apparatuses, the network configuration, and the like are not limited to those illustrated.

The in-vehicle communication system according to the present embodiment is a system that adopts a star network configuration in which a plurality of second relay apparatuses 20 and one wireless communication apparatus 30 are connected to one first relay apparatus 10 via communication lines 2. In this embodiment, communication between the first relay apparatus 10 and each of the second relay apparatuses 20 or the wireless communication apparatus 30 via the communication lines 2 is performed in accordance with the Ethernet (registered trademark) communication standard. The first relay apparatus 10 performs processing for relaying transmission/reception of data between a plurality of second relay apparatuses 20 and the wireless communication apparatus, in other words transmission/reception of data between the plurality of communication lines 2 connected to the first relay apparatus 10. Note that, in this embodiment, the first relay apparatus 10 and the second relay apparatuses 20 perform communication in accordance with the Ethernet communication standard, but there is no limitation to this. Various communication standards such as CAN (Controller Area Network), CAN-FD (CAN with Flexible Data-rate) and FlexRay can be adopted for communication between the first relay apparatus 10 and each of the second relay apparatuses 20.

In the in-vehicle communication system according to the present embodiment, the first relay apparatus 10 is mounted at the center of the vehicle 1, the second relay apparatuses 20 are mounted in six location, namely a right front portion, a right central portion, a right rear portion, a left front portion, a left central portion, and a left rear portion of the vehicle 1. Each of the second relay apparatuses 20 is connected to one or more ECUs 40 disposed in the vicinity thereof, via a communication line 3. That is, in the in-vehicle communication system according to the present embodiment, a plurality of ECUs 40 are grouped based on the mount position thereof in the vehicle 1, and a plurality of ECUs 40 in each group are connected to one second relay apparatus 20. A plurality of second relay apparatuses 20 are connected to the first relay apparatus 10, and communication between groups is performed by the first relay apparatus 10. Note that a plurality of ECUs 40 may be grouped in accordance with not only mount positions in the vehicle 1 but also various conditions such as functions of apparatuses or communication speeds.

In this embodiment, each second relay apparatus 20 and a plurality of ECUs 40 are connected via a common communication line 3, and constitutes a bus network. Communication between the second relay apparatus 20 and the ECUs 40 via the communication line 3 is performed in accordance with the CAN communication standard. The communication line 3 is called a “CAN bus”, and can be connected to several ECUs 40 to a dozen or so ECUs 40. FIG. 1 illustrates a configuration in which the ECUs 40 are connected only to the second relay apparatus 20 mounted in the right rear portion of the vehicle 1 via the communication line 3, but this is in order to simplify the drawing. In actuality, each of the other second relay apparatuses 20 is also connected to at least one communication line 3, and is connected to one or more ECUs 40 via the communication line 3. Note that, in this embodiment, the second relay apparatus 20 and the ECUs 40 perform communication in accordance with the CAN communication standard, but there is no limitation to this. Various communication standards such as Ethernet, CAN-FD, and FlexRay can be adopted for communication between the second relay apparatus 20 and the ECUs 40.

In this example, two communication lines 3 are connected to the second relay apparatus 20 in the right rear portion, two ECUs 40 are connected to one communication line 3, and one ECU 40 is connected to the other communication line 3. This second relay apparatus 20 relays data transmitted by an ECU 40 connected to one communication line 3 to the other communication line 3, and relays the data to the communication line 2. The second relay apparatus 20 may determine a destination of the received data based on identification information, namely what is known as a CAN ID, assigned to this data, for example. In this case, the second relay apparatus 20 stores, in advance, information regarding a table or the like in which CAN IDs to be assigned to data and communication lines that are relay destinations are associated with each other.

The wireless communication apparatus 30 can transmit/receive data to/from a server apparatus 50 that is present outside the vehicle 1, by performing communication using a wireless network such as a mobile phone communication network or a wireless LAN (Local Area Network). As described above, the wireless communication apparatus 30 is connected to the first relay apparatus 10 via the communication line 2, and the first relay apparatus 10 relays transmission/reception of data between the wireless communication apparatus 30 and the second relay apparatuses 20. Accordingly, each ECU 40 mounted in the vehicle 1 can transmit/receive data to/from the server apparatus 50 outside the vehicle 1, via the wireless communication apparatus 30, the first relay apparatus 10, and the second relay apparatus 20.

The ECUs 40 may include various ECUs such as an ECU for controlling the operation of the engine of the vehicle 1, an ECU for controlling the locking/unlocking of the doors, an ECU for controlling on/off of lights, an ECU for controlling the operation of the air bags, and an ECU for controlling the operation of the ABS (Antilock Brake System). In this embodiment, examples of in-vehicle communication apparatus that transmits/receives data via the communication lines 3 include the ECUs 40, but the in-vehicle communication apparatus is not limited to this.

There are cases where, for example, a new ECU 40 is mounted in the vehicle 1 to add a function to the vehicle 1, or the like, and is connected to the network in the vehicle 1. The in-vehicle communication system according to the present embodiment has a function of determining, when a new ECU 40 is connected to a communication line 3 to which one or more ECUs 40 are connected, whether or not this ECU 40 is an authorized apparatus, and restricting relay of data if the ECU is not an authorized apparatus. This restriction of relay is first performed by the second relay apparatus 20. In FIG. 1, for example, when a new ECU 40 is connected to one communication line 3 connected to the second relay apparatus 20 mounted in the right rear portion of the vehicle 1, the second relay apparatus 20 does not relay data that is transmitted by this new ECU 40, to the other communication line 3 or the communication line 2. When data given a CAN ID that is different from a CAN ID used for transmission/reception of data on a communication line 3 to this point in time is transmitted to the communication line 3, for example, the second relay apparatus 20 determines that a new ECU 40 has been connected, and restricts relay of (does not relay) data given this CAN ID.

After relay of data has been restricted, the second relay apparatus 20 performs behavior (operation) analysis and authentication processing of the new ECU 40. If the ECU 40 performs authorized behavior in behavior analysis and authentication of the ECU 40 is established in authentication processing, the second relay apparatus 20 cancels restriction of relay of data that is transmitted by this ECU 40. From this time on, the second relay apparatus 20 will relay data that is transmitted by this ECU 40 to the other communication line 3 and the communication line 2. If the ECU 40 does not exhibit authorized behavior in behavior analysis or authentication processing fails, the second relay apparatus 20 continues restriction of relay of data that is transmitted by the ECU 40, and may perform processing for notifying the user of the vehicle 1, the server apparatus 50, or the like of the result of behavior analysis or authentication processing.

In the in-vehicle communication system according to the present embodiment, relay is also restricted by the first relay apparatus 10. As described above, when data that is transmitted by an ECU 40 newly connected to a communication line 3 is relayed by the second relay apparatus 20, the data relayed by the second relay apparatus 20 is received by the first relay apparatus 10 via the communication line 2. When data given a CAN ID that is different from a CAN ID used for transmitting/receiving data on the communication line 2 to this point in time is received, the first relay apparatus 10 restricts relay of (does not relay) data given this CAN ID.

After restricting relay of data, the first relay apparatus 10 performs authentication processing of the newly connected ECU 40. Authentication processing between the first relay apparatus 10 and the ECU 40 is performed via the second relay apparatus 20. That is to say, the second relay apparatus 20 relays data related to authentication processing that is transmitted from the first relay apparatus 10 to the ECU 40, and also relays data related to authentication processing that is transmitted from the ECU 40 to the first relay apparatus 10. When authentication processing is successful, the first relay apparatus 10 cancels restriction of relay of data that is transmitted by this ECU 40. From this time on, the first relay apparatus 10 relays data that is transmitted by the ECU 40 to another communication line 2. If authentication processing fails, the first relay apparatus 10 may perform processing for notifying the user of the vehicle 1, the server apparatus 50, or the like that authentication processing has failed.

In this embodiment, after relay restriction has been canceled by the first relay apparatus 10 and relay of data is started, no other second relay apparatus 20 performs authentication processing of the ECU 40. The in-vehicle communication system according to the present embodiment can be regarded as a network having a hierarchical structure in which the first relay apparatus 10 is on a first layer, in other words the top layer, the second relay apparatuses 20 are on a second layer, and the ECUs 40 are on the third layer. The in-vehicle communication system can adopt a hierarchical structure that has four or more layers. When a new apparatus is added to the network, a relay apparatus on the layer immediately above this apparatus performs behavior analysis and authentication processing of the new apparatus, and apparatus on an even higher layer performs authentication processing. Authentication processing is performed from a lower layer to an upper layer in order, and if authentication processing on the top layer is successful, authentication of the new apparatus is complete.

### Apparatus Configuration

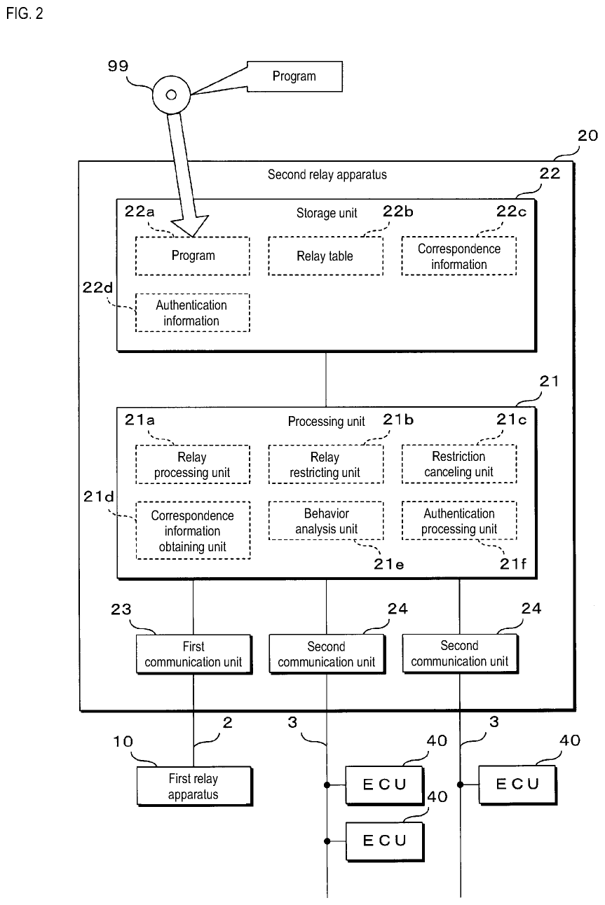

FIG. 2 is a block diagram showing a configuration of a second relay apparatus 20 according to the present embodiment. The second relay apparatus 20 according to the present embodiment is constituted by a processing unit (processor) 21, a storage unit (storage) 22, a first communication unit (transceiver) 23, and two second communication units (transceiver) 24. The processing unit 21 is constituted by a computation processing apparatus such as a CPU (Central Processing Unit) or an MPU (Micro-Processing Unit). The processing unit 21 can perform various types of processing by reading out and executing a program stored in the storage unit 22. In this embodiment, the processing unit 21 performs processing for relaying a message between communication lines 2 and 3, processing for restricting relay of a message, behavior analysis and authentication processing of a newly connected ECU 40, processing for cancelling restriction of relay of a message, and the like by reading out and executing a program 22a stored in the storage unit 22.

The storage unit 22 is constituted by a non-volatile memory element such as a flash memory or an EEPROM (Electrically Erasable Programmable Read Only Memory). The storage unit 22 stores various programs that are executed by the processing unit 21, and various types of data required for processing that is performed by the processing unit 21. In this embodiment, the storage unit 22 stores the program 22a that is executed by the processing unit 21, a relay table 22b for determining a destination of data in relay processing, correspondence information 22c for performing behavior analysis of a new ECU 40, and authentication information 22d for performing authentication processing of an ECU 40.

The program 22a may also be written in the storage unit 22 in a manufacturing stage of the second relay apparatus 20, for example, or may also be distributed by a remote server apparatus or the like and be obtained by the second relay apparatus 20 through communication, for example, or a program recorded in a recording medium 99 such as a memory card or an optical disk may be read out by the second relay apparatus 20 and stored in the storage unit 22, for example, or may also be read out and written in the storage unit 22 of the second relay apparatus 20 by a writing apparatus, for example. The program 22a may also be provided in the form of being distributed via a network, or may also be provided in the form of being recorded in the recording medium 99.

The relay table 22b is a table that is used for determining a destination of received data. The relay table 22b stores identification information such as a CAN ID that is given to data and identification information for identifying a communication line 2 or 3 that is a relay destination in association with each other.

The correspondence information 22c is information for performing behavior analysis of a newly connected ECU 40, and is information in which an input value that is input to the ECU 40 and an expected value of an output value that is output by the ECU 40 in response to this input value are associated with each other, for example. The storage unit 22 of the second relay apparatus 20 stores the correspondence information 22c in advance. Note that, when a new ECU 40 is connected to a communication line 3, the second relay apparatus 20 communicates with the server apparatus 50 via the wireless communication apparatus 30, and obtains the correspondence information 22c required for behavior analysis of the new ECU 40. In this case, after behavior analysis ends, the correspondence information 22c may be deleted from the storage unit 22.

The authentication information 22d is information for performing authentication processing of a newly connected ECU 40. The authentication information 22d can be information such as a public key or a private key.

The first communication unit 23 is connected to a communication line 2, and performs communication with the first relay apparatus 10 via the communication line 2. In this embodiment, the first communication unit 23 transmits/receives data in accordance with the Ethernet communication standard. The first communication unit 23 can be constituted by an IC (Integrated Circuit) of Ethernet PHY (physical layer), for example. The first communication unit 23 performs data transmission by outputting data provided from the processing unit 21, as an electrical signal to the communication line 2. The first communication unit 23 samples and obtains the potential of the communication line 2, thereby converts the electrical signal on the communication line 2 into digital data, and provides the digital data as received data to the processing unit 21.

The second relay apparatus 20 according to the present embodiment includes two second communication units 24. Each of the second communication units 24 is connected to a communication line 3, and communicates with one or more ECUs 40 via the communication line 3. In this embodiment, the second communication units 24 transmits/receives data in accordance with the CAN communication standard. The second communication unit 24 can be constituted by an IC of a CAN controller, for example. The second communication unit 24 outputs data provided from the processing unit 21, as an electrical signal to the communication line 3, and thereby transmits the data. The second communication units 24 samples and obtains the potential on the communication line 3, thereby converts the electrical signal on the communication line 3 into digital data, and provides the digital data as received data to the processing unit 21. When a plurality of apparatuses transmit data to the communication line 3 at the same time, the second communication unit 24 performs arbitration processing for determining one of the apparatuses to be provided with transmission rights.

A relay processing unit 21a, a relay restricting unit 21b, a restriction cancelling unit 21c, a correspondence information obtaining unit 21d, a behavior analysis unit 21e, an authentication processing unit 21f, and the like of the second relay apparatus 20 according to this embodiment are realized as software-like functional blocks in the processing unit 21 by the processing unit 21 reading out and executing the program 22a stored in the storage unit 22. The relay processing unit 21a transmits data received by one communication unit out of the first communication unit 23 and the second communication units 24, from another communication unit out of the first communication unit 23 and the second communication units 24, thereby performing processing for relaying the data. The relay processing unit 21a obtains the CAN ID given to the received data, refers to the relay table 22b of the storage unit 22, and checks for a destination associated with the CAN ID, in the relay table 22b. The relay processing unit 21a provides the data to the destination designated in the relay table 22b, namely one of the first communication unit 23 and the second communication units 24, and causes the designated first communication unit 23 or second communication unit 24 to transmit this data.

The relay restricting unit 21b performs processing for restricting relay of data that is performed by the relay processing unit 21a. Regarding data transmitted by the ECU 40 newly connected to the communication line 3, the relay restricting unit 21b restricts relay of the data to the communication line 2 and another communication line 3 that is performed by the relay processing unit 21a. If the CAN ID given to the data received by the second communication unit 24 is a CAN ID that has not been received by this second communication unit 24 to this point in time, for example, then the relay restricting unit 21b determines that this data has been transmitted by a new ECU 40, and does not allow the relay processing unit 21a to relay the data. Relay of data is restricted by the relay restricting unit 21b, for example, by registering the CAN ID of the data for which relay is restricted, in the relay table 22b. The relay processing unit 21a does not relay data of this CAN ID, if a flag or the like indicating that relay is prohibited is set in the relay table 22b.

The restriction cancelling unit 21c performs processing for cancelling restriction of relay of data that is performed by the relay restricting unit 21b. If it is determined that the newly connected ECU 40 is an authorized apparatus based on the results of behavior analysis and authentication processing performed on this ECU 40, the restriction cancelling unit 21c cancels restriction of relay. The restriction cancelling unit 21c can cancel restriction of relay, for example, by performing processing for changing the relay prohibition flag set in the relay table 22b to “relay permitted”.

The correspondence information obtaining unit 21d performs processing for obtaining correspondence information for performing behavior analysis of the newly connected ECU 40. The correspondence information obtaining unit 21d obtains correspondence information regarding the ECU 40 that is an analysis target, by communicating with the server apparatus 50 via the wireless communication apparatus 30, and stores the correspondence information in the storage unit 22. The correspondence information obtaining unit 21d obtains correspondence information from the server apparatus 50 based on a CAN ID for which relay of data has been restricted by the relay restricting unit 21b, or obtains information regarding the apparatus such as the apparatus ID or the manufacturing number from the ECU 40 for which relay has been restricted, for example, and obtains correspondence information from the server apparatus 50 based on the obtained information regarding the apparatus.

The behavior analysis unit 21e performs behavior analysis of the ECU 40 for which relay of data has been restricted, using the correspondence information 22c obtained by the correspondence information obtaining unit 21d and stored in the storage unit 22. The correspondence information 22c is what is known as a test pattern for checking the behavior of the ECU 40. The correspondence information 22c stores an input value that is input to the ECU 40 and an expected value of an output value that is output by the ECU 40 in response to this input value in association. The behavior analysis unit 21e obtains the input value of the correspondence information 22c, and transmits the input value as transmission data from the second communication unit 24 to the ECU 40. The ECU 40 that has received this data performs predetermined processing on this data, and transmits an output value, which a processing result, as transmission data to the second relay apparatus 20. The behavior analysis unit 21e receives the data from the ECU 40, and can determines whether or not the ECU 40 is an authorized apparatus, based on whether or not the output value included in the received data matches the expected value in the correspondence information 22c.

The authentication performs authentication processing of the ECU 40 for which relay of data has been restricted by the relay restricting unit 21b, using the authentication information 22d stored in the storage unit 22. In this embodiment, information regarding a shared key is stored as the authentication information 22d, and if the ECU is an authorized apparatus, it is assumed that the ECU 40 has the same shared key. Authentication processing is performed in the following procedure, for example. The authentication processing unit 21f generates random numbers, and transmits the random numbers to the ECU 40. The ECU 40 that has received the random numbers calculates a hash value using a predetermined hash function based on the random numbers and the shared key stored in the ECU 40, and transmits the hash value to the second relay apparatus 20. The authentication processing unit 21f of the second relay apparatus 20 that has received the hash value from the ECU 40 calculates a hash value based on the random numbers transmitted to the ECU 40 and the shared key stored in the authentication processing unit 21f, using a predetermined hash function, and determines whether or not the hash value calculated by the authentication processing unit 21f and the hash value received from the ECU 40 match. If the two hash values match, the authentication processing unit 21f determines that this ECU 40 is an authorized apparatus, and authentication processing is successful.

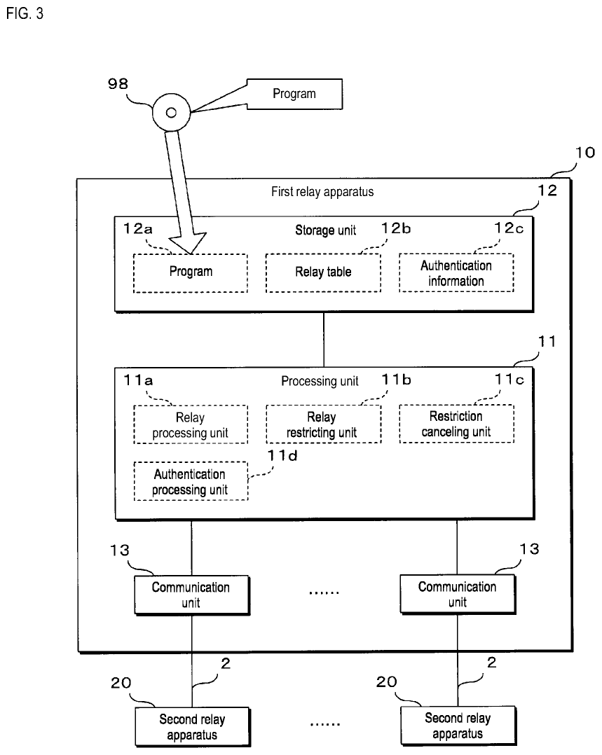

FIG. 3 is a block diagram showing a configuration of the first relay apparatus 10 according to the present embodiment. The first relay apparatus 10 according to the present embodiment is constituted by a processing unit (processor) 11, a storage unit (storage) 12, and a plurality of communication units (transceivers) 13. The processing unit 11 is constituted by a computation processing apparatus such as a CPU or an MPU. The processing unit 11 can perform various types of processing by reading out and executing a program stored in the storage unit 12. In this embodiment, the processing unit 11 performs processing for relaying a message between a plurality of communication lines 2, processing for restricting relay of a message, authentication processing of the newly connected ECU 40, processing for cancelling restriction of relay of a message, and the like, by reading out and executing a program 12a stored in the storage unit 12.

The storage unit 12 is constituted by a non-volatile memory element such as a flash memory or an EEPROM. The storage unit 12 stores various programs that are executed by the processing unit 11, and various types of data required for processing that is performed by the processing unit 11. In this embodiment, the storage unit 12 stores the program 12a that is executed by the processing unit 11, a relay table 12b for determining a destination of data in relay processing, and authentication information 12c for performing authentication processing with the ECU 40.

The program 12a may also be written in the storage unit 12 in a manufacturing stage of the first relay apparatus 10, for example, or may also be distributed by a remote server apparatus or the like and be obtained by the first relay apparatus 10 through communication, for example, or a program recorded in a recording medium 98 such as a memory card or an optical disk may be read out by the first relay apparatus 10 and stored in the storage unit 12, for example, or may also be read out and written in the storage unit 12 of the first relay apparatus 10 by a writing apparatus, for example. The program 12a may also be provided in the form of being distributed via a network, or may also be provided in the form of being recorded in the recording medium 98.

The relay table 12b is a table that is used for determining a destination of received data. The authentication information 12c is information for performing authentication processing of the newly connected ECU 40. The relay table 12b, the authentication information 12c, and the like of the first relay apparatus 10 have substantially the same configurations as the relay table 22b and the authentication information 22d of the second relay apparatuses 20, and thus a description thereof is omitted.

Each communication unit 13 is connected to a communication line 2, and performs communication with the second relay apparatus 20 via the communication line 2. In this embodiment, the communication unit 13 transmits/receives data in accordance with the Ethernet communication standard. The communication unit 13 can be constituted by an IC of EthernetPHY, for example. In this embodiment, the first relay apparatus 10 includes seven communication units 13, but FIG. 3 does not illustrate all of the communication units 13.

A relay processing unit 11a, a relay restricting unit 11b, a restriction cancelling unit 11c, an authentication processing unit 11d, and the like of the first relay apparatus 10 according to this embodiment are realized as software-like functional blocks in the processing unit 11 by the processing unit 11 reading out and executing the program 12a stored in the storage unit 12. The relay processing unit 11a transmits data received by one communication unit 13, from another communication unit 13, thereby relaying data. At this time, the relay processing unit 11a determines a relay destination using the relay table 12b of the storage unit 12.

The relay restricting unit 11b performs processing for restricting relay of data that is performed by the relay processing unit 11a. Regarding the ECU 40 that has been newly connected to a communication line 3 and for which restricting of relay that is performed by the second relay apparatus 20 has been canceled, the relay restricting unit 11b restricts data that is transmitted by this ECU 40 from being relayed to another communication line 2. If the CAN ID given to the data received by the communication unit 13 is a CAN ID that has not been received by this communication unit 13 to this point in time, for example, then the relay restricting unit 11b determines that this data has been transmitted by the new ECU 40, and does not allow the relay processing unit 11a to relay the data.

The restriction cancelling unit 11c performs processing for cancelling restriction of relay of data performed by the relay restricting unit 11b. If it is determined that the newly connected ECU 40 is an authorized apparatus, based on the result of authentication processing that is performed on this ECU 40, the restriction cancelling unit 11c cancels relay restriction.

The authentication processing unit 11f performs authentication processing of the ECU 40 for which relay of data has been restricted by the relay restricting unit 11b, using the authentication information 12c stored in the storage unit 12. The procedure of authentication processing is similar to authentication processing that is performed by the authentication processing unit 21f of the second relay apparatus 20.

### Restriction of Relay and Cancellation of Restriction

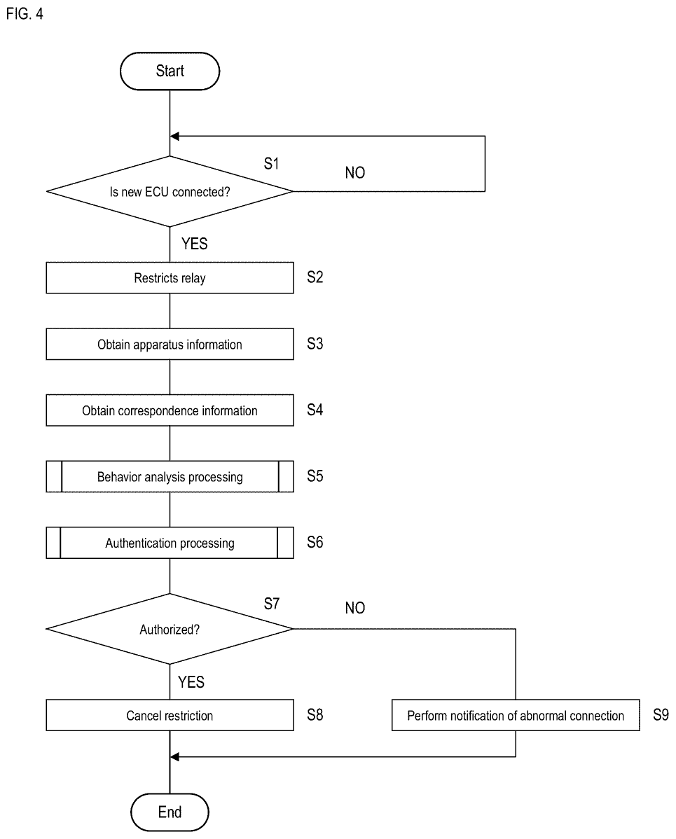

FIG. 4 is a flowchart showing the procedure of processing that is performed by each second relay apparatus 20 according to the present embodiment. The relay restricting unit 21b of the processing unit 21 of the second relay apparatus 20 according to the present embodiment determines whether or not a new ECU 40 is connected to a communication line 3 (step S1). When a new ECU 40 is not connected (step S1: NO), the relay restricting unit 21b waits until a new ECU 40 is connected.

The relay restricting unit 21b transmits a request to obtain information such as an apparatus ID or a manufacturing number, to one or more ECUs 40 connected to the communication line 3 at the same time, for example, and determines whether or not a new ECU 40 is connected, based on data transmitted from the ECUs 40, as a response to this request. The relay restricting unit 21b can determine whether or not a new ECU 40 is connected, by receiving the data transmitted from the ECUs 40 in accordance with the obtaining request, storing the data, repeating the obtaining request periodically, and examining whether or not there is a change from past data.

When data given a CAN ID that has not received to this point in time is received for example, the relay restricting unit 21b can determine that a new ECU 40 has been connected. A configuration may also be adopted in which, for example, the newly connected ECU 40 notifies the second relay apparatus 20 that a new ECU 40 has been connected, and, in this case, the relay restricting unit 21b can determine whether or not a new ECU 40 has been connected, in accordance with whether or not such a notification has been received.

When a new ECU 40 is connected (step S1: YES), the relay restricting unit 21b restricts relay of data that is transmitted by this ECU 40 (step S2). The relay restricting unit 21b can restricts relay of data, for example, by setting, in the relay table 22b of the storage unit 22, a flag for prohibiting relay of data that is transmitted by this ECU 40.

Next, the correspondence information obtaining unit 21d of the processing unit 21 obtains apparatus information regarding the apparatus ID or the manufacturing number of the newly connected ECU 40 (step S3). The correspondence information obtaining unit 21d can obtain apparatus information, for example, by requesting the newly connected ECU 40 to transmit predetermined information and receiving data that is transmitted by the ECU 40 in accordance with this request. The correspondence information obtaining unit 21d obtains correspondence information required for behavior analysis of this apparatus, from the server apparatus 50, based on the apparatus information obtained in step S3, (step S4), and stores the correspondence information in the storage unit 22.

The behavior analysis unit 21e of the processing unit 21 performs behavior analysis processing of the newly connected ECU 40, using the correspondence information obtained in step S4 (step S5). The authentication processing unit 21f of the processing unit 21 performs authentication processing of the newly connected ECU 40 using the authentication information 22d stored in the storage unit 22 (step S6). The behavior analysis processing that is performed in step S5 and the authentication processing that is performed in step S6 will be described in detail later. The restriction cancelling unit 21c of the processing unit 21 determines whether or not the newly connected ECU 40 is an authorized apparatus, based on the results of the behavior analysis processing in step S5 and the authentication processing in step S6 (step S7).

If it is determined that the newly connected ECU 40 is an authorized apparatus (step S7: YES), the restriction cancelling unit 21c of the processing unit 21 cancels restriction of relay of data that is transmitted by this ECU 40 (step S8), and ends the processing. The restriction cancelling unit 21c can cancel restriction of relay by changing the relay prohibition flag set in the relay table 22b of the storage unit 22 by the relay restricting unit 21b to “permitted”. If it is determined that the newly connected ECU 40 is not an authorized apparatus (step S7: NO), the processing unit 21 performs notification that an abnormal ECU 40 has been connected to a communication line 3 (step S9), and ends the processing. The processing unit 21 can perform notification, for example, by displaying a message on a display or the like mounted in the vehicle 1, or by transmitting data that includes abnormal content to the server apparatus 50 via the wireless communication apparatus 30.

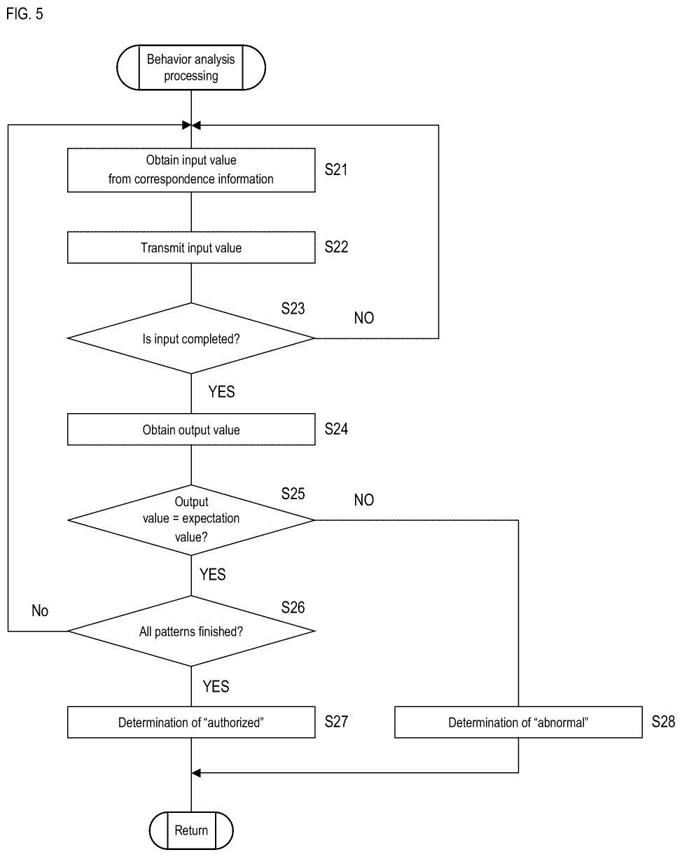

FIG. 5 is a flowchart showing the procedure of behavior analysis processing that is performed by the second relay apparatus 20 according to the present embodiment, which is processing that is performed in step S5 in the flowchart shown in FIG. 4. Correspondence information that is obtained from the server apparatus 50 and stored in the storage unit 22 by the second relay apparatus 20 according to the present embodiment is information in which an input value for causing the ECU 40 to perform predetermined behavior, namely what is known as a test pattern, is associated with an expected value of an output value that is output when the ECU 40 performs predetermined behavior in response to this input value. A combination of a plurality of values may be used as the input value, and examples thereof may include a control command or the like for the ECU 40. A plurality of pairs of input values and output values may be included in the correspondence information, and the second relay apparatus 20 may analyze behavior of the ECU 40 using a plurality of test patterns.

The behavior analysis unit 21e of the processing unit 21 of the second relay apparatus 20 according to the present embodiment obtains, from the correspondence information 22c stored in the storage unit 22, the input value that is input to the ECU 40 that is an analysis target (step S21). The behavior analysis unit 21e provides transmission data that includes the obtained input value, to the second communication unit 24 corresponding to the communication line 3 connected to this ECU 40, thereby transmitting the input value to the ECU 40 (step S22). The behavior analysis unit 21e determines whether or not input of all of the input values related to one test pattern to the ECU 40 is completed (step S23). If input of all of the input values is not completed (step S23: NO), the behavior analysis unit 21e returns the procedure to step S21, and continues to input the remaining input values required for this test pattern.

If input of all of the input values for one test pattern is complete (step S23: YES), the behavior analysis unit 21e obtains an output value that has been output by the ECU 40 as a result of performing predetermined behavior in response to this input (step S24). At this time, the ECU 40 transmits data that includes the output value to the communication line 3, and this data is received by the second communication unit 24, whereby the behavior analysis unit 21e can obtain the output value. Next, the behavior analysis unit 21e compares the output value obtained in step S24 with an expected value of this test pattern included in the correspondence information 22c, and determines whether or not the output value and the expected value match (step S25).

If the output value and the expected value match (step S25: YES), the behavior analysis unit 21e determines that authorized behavior has been performed for this test pattern, and determines whether or not all of the test patterns included in the correspondence information 22c have been finished (step S26). If all of the test patterns have not been finished, to carry out the next test pattern (step S26: NO), the behavior analysis unit 21e returns the procedure to step S21, and performs similar processing for the next test pattern. If all of the test patterns have been finished (step S26: YES), the behavior analysis unit 21e determines that the ECU 40 that is an analysis target is an authorized apparatus (step S27), and ends the behavior analysis processing. If the output value and the expected value do not match (step S25: NO), the behavior analysis unit 21e determines that the ECU 40 that is an analysis target is not an authorized apparatus, in other words an abnormal apparatus (step S28), and ends the behavior analysis processing.

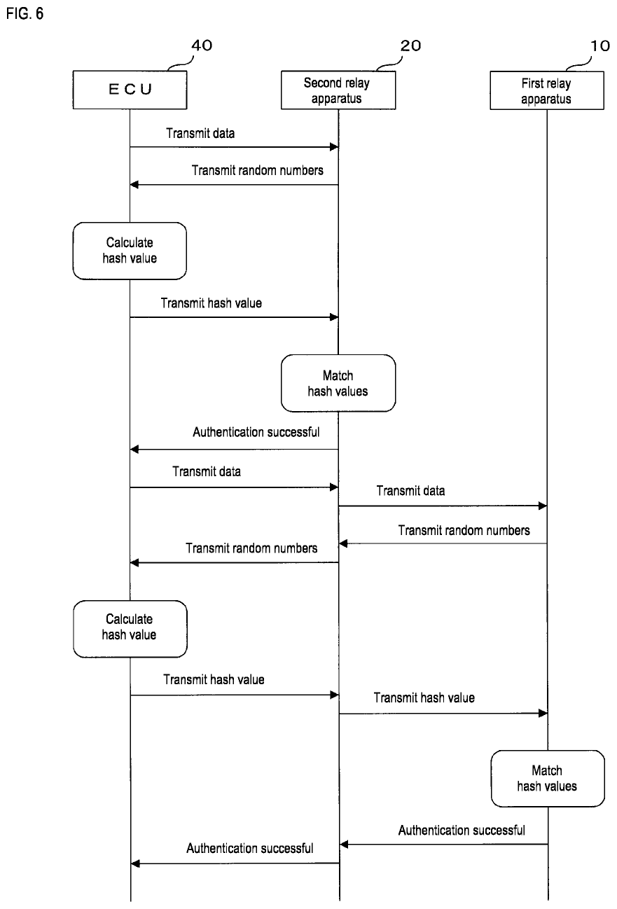

FIG. 6 is a schematic diagram for describing an overview of authentication processing that is performed by the in-vehicle communication system according to the present embodiment. In the in-vehicle communication system according to the present embodiment, a network having a hierarchical structure in which a plurality of second relay apparatuses 20 are connected to one first relay apparatus 10 and a plurality of ECUs 40 are connected to each of the second relay apparatuses 20 is adopted. In the in-vehicle communication system according to the present embodiment, authentication processing of a newly connected ECU 40 is performed by the second relay apparatus 20 and the first relay apparatus 10 that are on the upper layers, thereby improving the reliability of authentication processing. In this embodiment, what is known as challenge-response authentication processing is performed.

An ECU 40 newly connected to a communication line 3 transmits authentication request data to the communication line 3, and this authentication request data is received by the second relay apparatus 20. The second relay apparatus 20 determines that the ECU 40 that has transmitted this authentication request data is a newly connected ECU 40, and starts authentication processing of the ECU 40. First, the second relay apparatus 20 generates random numbers, and transmits the generated random numbers to the ECU 40. This transmitting of random numbers corresponds to “challenge” in the challenge-response method. The ECU 40 that has received the random numbers calculates a hash value based on the received random numbers and the shared key stored therein, using a predetermined hash function. The ECU 40 transmits the calculated hash value to the second relay apparatus 20. This transmitting of the hash value corresponds to “response” in the challenge-response method.

The second relay apparatus 20 that has received the hash value from the ECU 40 calculates a hash value based on the random numbers transmitted to the ECU 40 and a shared key stored in the second relay apparatus 20, using a predetermined hash function. It is assumed that an authorized ECU 40 stores the same shared key as that of the second relay apparatus 20 and can calculate a hash value using the same hash function. “The second relay apparatus 20 performs matching of hash values, in other words determines whether or not the hash value received from the ECU 40 and the hash value calculated by the second relay apparatus 20 match. If the two hash values match, the second relay apparatus 20 determines that authentication has been successful, and notifies that authentication was successful to the ECU 40.

In the in-vehicle communication system according to the present embodiment, after authentication processing between the second relay apparatus 20 and the ECU 40 has been successful, authentication processing between the first relay apparatus 10 and the ECU 40 is performed. Since authentication processing between the second relay apparatus 20 and the ECU 40 has been successful, the second relay apparatus 20 can relay data transmitted by the ECU 40, to the first relay apparatus 10. When authentication processing is being performed between the ECU 40 and the first relay apparatus 10, the second relay apparatus 20 relays data related to authentication processing that is transmitted/received between the ECU 40 and the first relay apparatus 10.

After authentication processing of the second relay apparatus 20 ends, the ECU 40 transmits data to the first relay apparatus 10 via the second relay apparatus 20, and this data is received by the first relay apparatus 10. The first relay apparatus 10 starts authentication processing of the ECU 40 that has transmitted this data. First, the first relay apparatus 10 generates random numbers, and transmits the generated random numbers to the ECU 40. The ECU 40 that has received this random numbers calculates a hash value based on the received random numbers and a shared key stored in the ECU 40, using a predetermined hash function. The shared key stored in the first relay apparatus 10 and the shared key stored in the second relay apparatus 20 are different, and the ECU 40 needs to store both the shared keys in advance. The ECU 40 transmits the calculated hash value to the first relay apparatus 10.

The first relay apparatus 10 that has received the hash value from the ECU 40 calculates a hash value based on the random numbers transmitted to the ECU 40 and the shared key stored in the first relay apparatus 10 using a predetermined hash function. The first relay apparatus 10 performs matching of hash values, in other words determines whether or not the hash value received from the ECU 40 and the hash value calculated by the first relay apparatus 10 match. If the two hash values match, the first relay apparatus 10 determines that authentication has been successful, and notifies it to the ECU 40.

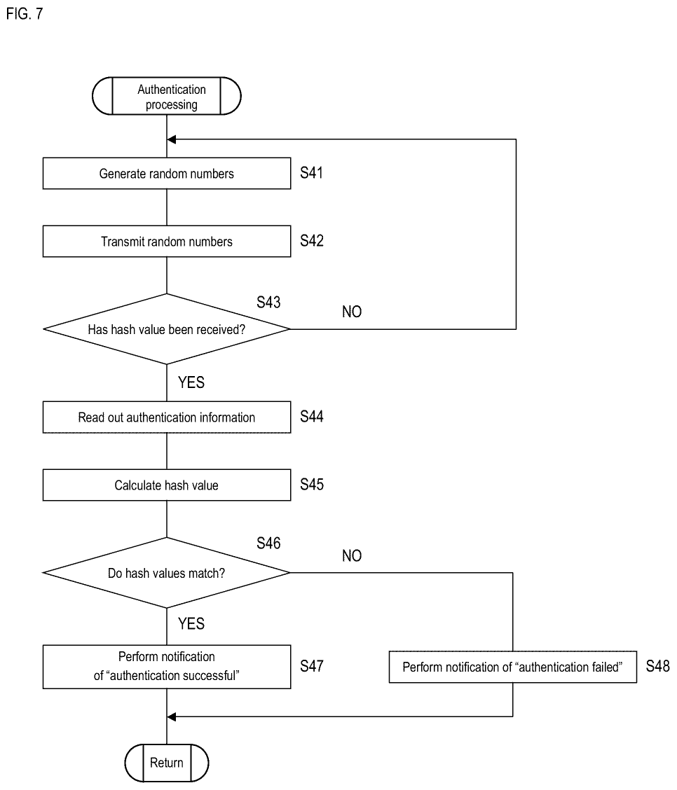

FIG. 7 is a flowchart showing the procedure of authentication processing that is performed by the second relay apparatus 20 according to the present embodiment, in step S6 in the flowchart shown in FIG. 4. The authentication processing unit 21f of the processing unit 21 of the second relay apparatus 20 according to the present embodiment generates random numbers using a predetermined random number generation algorithm (step S41). The authentication processing unit 21f transmits the generated random numbers to the ECU 40 that is an authentication partner by transmitting data that includes the random numbers via a second communication units 24 (step S42). The authentication processing unit 21f then determines whether or not a hash value that is transmitted by the ECU 40 in response to the random numbers is received before a predetermined waiting time elapses (step S43). If a hash value from the ECU 40 is not received before the waiting time has elapsed (step S43: NO), the authentication processing unit 21f returns the procedure to step S41, and generates and transmits random numbers again. Note that, if no hash value is received even when random numbers are repeatedly generated and transmitted a predetermined number of times, the authentication processing unit 21f may determine that authentication processing has failed.

When a hash value from the ECU 40 is received (step S43: YES), the authentication processing unit 21f reads out the authentication information 22d stored in the storage unit 22 (step S44). The authentication processing unit 21f calculates a hash value based on the random numbers generated in step S41 and the shared key included in the authentication information 22d read out in step S44, using a predetermined hash function (step S45). The authentication processing unit 21f compares the hash value of the ECU 40 received in step S43 with the hash value calculated by the authentication processing unit 21f in step S45, and determines whether or not the two hash values match (step S46). If the two hash values match (step S46: YES), the authentication processing unit 21f notifies the ECU 40 that authentication has been successful (step S47), and ends the authentication processing. If the two hash values do not match (step S46: NO), the authentication processing unit 21f notifies the ECU 40 that authentication has failed (step S48), and ends the authentication processing.

Note that, in this embodiment, if it is determined once that the hash values do not match, the authentication processing unit 21f determines that authentication has failed, but there is no limitation to this. A configuration may also be adopted in which, for example, if the hash values do not match, the authentication processing unit 21f performs redetermination by returning the procedure to step S1, and if the hash values do not match even when redetermination is performed a predetermined number of times, the authentication processing unit 21f determines authentication has failed.

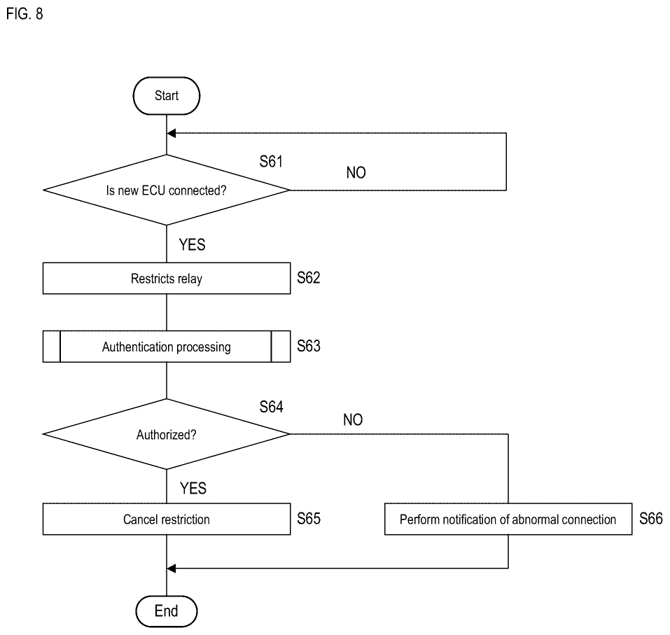

FIG. 8 is a flowchart showing the procedure of processing that is performed by the first relay apparatus 10 according to the present embodiment. The relay restricting unit 11b of the processing unit 11 of the first relay apparatus 10 according to the present embodiment determines whether or not a new ECU 40 is connected to the network within the vehicle 1 (step S61). The relay restricting unit 11b, for example, transmits a request to obtain information such as the apparatus ID or the manufacturing number, to one or more ECUs 40 connected to the communication line 3 at the same time, and can thus determine whether or not a new ECU 40 is connected, based on data that is transmitted from the ECUs 40 as a response to this request. If a new ECU 40 is not connected (step S61: NO), the relay restricting unit 11b waits until a new ECU 40 is connected.

When a new ECU 40 is connected (step S61: YES), the relay restricting unit 11b restricts relay of data that is transmitted by this ECU 40 (step S62). The relay restricting unit 11b can restrict relay of data, for example, by setting, in the relay table 12b of the storage unit 12, a flag for prohibiting relay of data that is transmitted by this ECU 40. Next, the authentication processing unit 11d of the processing unit 11 performs authentication processing of the newly connected ECU 40 using the authentication information 12c stored in the storage unit 12 (step S63). The authentication processing that is performed in step S63 is performed in the same procedure as the authentication processing that is performed by the second relay apparatuses 20 shown in FIG. 7, and thus a detailed description is omitted.

The restriction cancelling unit 11c of the processing unit 11 determines whether or not the newly connected ECU 40 is an authorized apparatus based on the result of authentication processing in step S63 (step S64). If it is determined that the newly connected ECU 40 is an authorized apparatus (step S64: YES), the restriction cancelling unit 11c cancels restriction of relay of data that is transmitted by this ECU 40 (step S65), and ends the processing. The restriction cancelling unit 11c can cancel restriction of relay by changing, to “permitted”, a relay prohibition flag set in the relay table 12b of the storage unit 12 by the relay restricting unit 11b. If it is determined that the newly connected ECU 40 is not an authorized apparatus (step S64: NO), the processing unit 11 performs notification that an abnormal ECU 40 has been connected (step S66), and ends the processing. The processing unit 11 can perform notification, for example, by displaying a message on a display or the like mounted in the vehicle 1, or by transmitting data that includes abnormal content to the server apparatus 50 via the wireless communication apparatus 30.

### Overview

In the in-vehicle communication system according to the present embodiment that has the above-described configuration, each second relay apparatus 20 to be connected to a plurality of communication lines 2 and 3, and that relays transmission/reception of data between the communication lines 2 and 3 restricts data that is transmitted by an ECU 40 newly connected to one communication line 3 from being relayed to the other communication lines 2 and 3. The second relay apparatus 20 performs behavior analysis of the newly connected ECU 40 based on the predetermined correspondence information 22c of the ECU 40. If it is determined that, as a result of behavior analysis, for example, the newly connected ECU 40 is an authorized ECU, the second relay apparatus 20 cancels restriction of relay, and relays data that is transmitted by this ECU 40 to the other communication lines 2 and 3. Accordingly, the second relay apparatus 20 can relay data that is transmitted by an ECU 40 that performs authorized behavior, and restrict relay of data that is transmitted by an ECUs 40 that does not perform authorized behavior. Thus, the second relay apparatus 20 can prevent an adverse effect from data that is transmitted by the ECU 40 that does not perform authorized behavior, from covering the other communication lines 2 and 3.

In the in-vehicle communication system according to the present embodiment, the second relay apparatus 20 obtains correspondence information for performing behavior analysis from the server apparatus 50 outside the vehicle 1 via the wireless communication apparatus 30. Accordingly, the second relay apparatus 20 can obtain required correspondence information from the external server apparatus 50 and perform behavior analysis without storing a large amount of correspondence information in the storage unit 22 in advance.

In the in-vehicle communication system according to the present embodiment, the correspondence information 22c that is used for behavior analysis includes an input value that is input to an ECU 40 and an expected value of an output value that is output by the ECU 40 in response to this input value. The second relay apparatus 20 inputs an input value that serves as a test pattern to the ECU 40 based on the correspondence information 22c, and obtains an output value of the ECU 40 output in response to this input. The second relay apparatus 20 compares the output value obtained from the ECU 40 with an expected value included in the correspondence information 22c, and can determine whether or not behavior of this ECU 40 is authorized.

In the in-vehicle communication system according to the present embodiment, authentication processing is performed between the second relay apparatus 20 and the ECU 40. Challenge-response authentication processing that uses a shared key can be adopted as the authentication processing, for example. The second relay apparatuses 20 cancels restriction of relay of data that is transmitted by the ECU 40 based on a result of behavior analysis and a result of authentication processing. Accordingly, the second relay apparatus 20 relays data that is transmitted from the ECU 40 that performs authorized behavior and has been determined as being authorized, making it possible to improve the reliability of data that is being relayed.

In the in-vehicle communication system according to the present embodiment, not only authentication processing between the ECU 40 and the second relay apparatus 20 but also authentication processing between the ECU 40 and the first relay apparatus 10 is performed. After restriction of relay of data that is transmitted by the ECU 40 has been canceled, the second relay apparatus 20 relays data related to authentication processing that is performed between the ECU 40 and the first relay apparatus 10. In this manner, as a result of enabling a plurality of relay apparatuses to perform authentication processing on the newly connected ECU 40, instead of only one relay apparatus performing authentication processing with the newly connected ECU 40, it is possible to improve the reliability of communication in the vehicle 1.

In this embodiment, the second relay apparatus 20 performs behavior analysis and authentication processing, and determines whether or not the ECU 40 is an authorized apparatus, but there is no limitation to this, and the second relay apparatuses 20 may perform only one of behavior analysis and authentication processing and determine whether or not the ECU 40 is an authorized apparatus. The first relay apparatus 10 performs only authentication processing with the ECU 40, but there is no limitation to this, and the first relay apparatus 10 may perform both behavior analysis and authentication processing of the ECU 40. The first relay apparatus 10 and the second relay apparatus 20 perform authentication processing on the ECU 40, but there is no limitation to this, and a configuration may also be adopted in which only one of the first relay apparatus 10 and the second relay apparatus 20 perform authentication processing. In addition, the second relay apparatus 20 according to the present embodiment performs authentication processing after performing behavior analysis, but there is no limitation to this, and the second relay apparatus 20 may perform behavior analysis after performing authentication processing. The arrangement of the apparatuses in the in-vehicle communication system shown in FIG. 1, the number of mounted apparatuses, the network configuration, and the like are exemplary, and there is no limitation to these.

### Second Embodiment

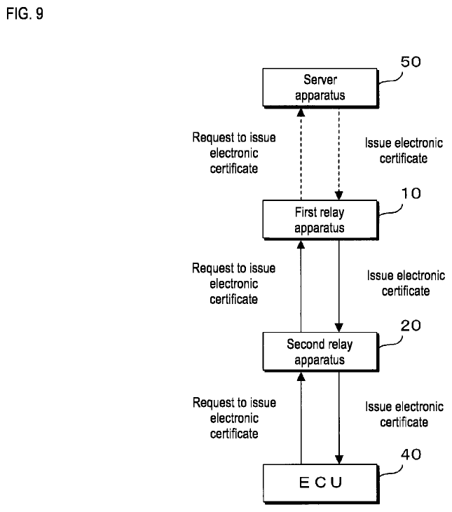

An in-vehicle communication system according to a second embodiment performs authentication that uses a digital certificate, instead of performing challenge-response authentication processing that uses a shared private key, as a method for authenticating an ECU 40. FIG. 9 is a schematic diagram for describing a method for authenticating the ECU 40 that is performed by the in-vehicle communication system according to the second embodiment. The in-vehicle embodiment performs communication system according to the second communication that uses what is known as a public key encryption technique. The first relay apparatus 10, the second relay apparatus 20, and the ECU 40 included in the in-vehicle communication system have a private key for encrypting data to be transmitted or a hash value of this data and a public key for decrypting the encrypted data.

The ECU 40 attaches an electronic signature that includes encrypted data encrypted using a private key, a public key for decrypting this, and information regarding digital certificate proving that this public key is an authorized key to transmission data, and transmits the transmission data to another ECU 40 or the like, for example. The ECU 40 stores the information regarding the issued digital certificate, and uses the stored information regarding the digital certificate every time data is transmitted. The digital certificate of the ECU 40 that is required at this time is created by the second relay apparatus 20. Similarly, the digital certificate of the second relay apparatus 20 is created by the first relay apparatus 10, and the digital certificate of the first relay apparatus 10 is created by the server apparatus 50. In the in-vehicle communication system according to the second embodiment, the server apparatus 50 performs the role of an authentication station that issues a digital certificate.

As shown in FIG. 9, the in-vehicle communication system according to the second embodiment has a system configuration in which the server apparatus 50, the first relay apparatus 10, the second relay apparatus 20, and the ECU 40 are hierarchized in the stated order from the top. When one of the first relay apparatus 10, the second relay apparatus 20, and the ECU 40 is newly connected to the in-vehicle communication system, this apparatus transmits a request to issue a digital certificate, to an apparatus positioned on the layer immediately above the newly connected apparatus. The server apparatus 50, the first relay apparatus 10, or the second relay apparatus 20 receives a request to issue a digital certificate, the request having been transmitted from an apparatus on the layer immediately below, creates information regarding a digital certificate according to this request, and transmits the created information regarding a digital certificate to the apparatus that has made the request.

Another apparatus that has received data having a digital certificate attached thereto and transmitted by the ECU 40 can determine whether or not the digital certificate is authorized, using the public key of the second relay apparatus 20, which has created this digital certificate, and decrypt the data encrypted using the public key of the ECU 40 attached to the digital certificate determined as being authorized. When transmission data of the ECU 40 is relayed between a plurality of communication lines 3 connected to the second relay apparatus 20, the second relay apparatus 20 transmits data received on one communication line, directly to another communication line. When data received on one communication line 3 is relayed to the communication line 2, that is to say, the first relay apparatus 10, the second relay apparatus 20 attaches a digital certificate thereof to transmission data, and transmits the data to the communication line 2. The first relay apparatus 10 receives the data from the second relay apparatus 20 through one communication line 2, and directly transmits the received data to another communication line 2. When communicating with the server apparatus 50 or the like outside the vehicle 1 via the wireless communication apparatus 30, the first relay apparatus 10 attaches information regarding the digital certificate thereof to the transmission data.

When requested to create a digital certificate from the ECU 40, the second relay apparatus 20 performs the above-described behavior analysis on the ECU 40 that has made the request, and issues a digital certificate for the ECU 40 determined through behavior analysis as having performed authorized behavior. The first relay apparatus 10 may perform behavior analysis of the second relay apparatus 20 in accordance with a request to create a digital certificate from the second relay apparatus 20.

The in-vehicle communication system according to the second embodiment that has the above-described configuration has a hierarchical network configuration, and performs authentication of an apparatus mounted in the vehicle 1 in a hierarchical manner. Accordingly, the in-vehicle communication system according to the second embodiment can localize the range of influence with respect to leaking of a private key and the like, making it possible to improve the reliability of communication. The in-vehicle communication system according to the second embodiment can distribute the load of authentication processing.

Other configurations of the in-vehicle communication system according to the second embodiment are similar to those of the in-vehicle communication system according to the first embodiment, and thus similar portions are given the same reference numerals, and a detailed description thereof is omitted.

Each apparatus in the in-vehicle communication system includes a computer constituted by a microprocessor, a ROM, a RAM, and the like. A computation processing unit such as a microprocessor may read out a computer program that includes some or all of the steps in a sequence chart or a flowchart such as those shown in FIGS. 4 to 8, from a storage unit such as a ROM or a RAM, and execute the program. Computer programs of these apparatuses can be installed from an external server apparatus or the like. Also, the computer programs of these apparatuses are distributed in a state of being stored in a recording medium such as a CD-ROM, a DVD-ROM, or a semiconductor memory. In addition, various types of processing described in the embodiments may be performed by a microprocessor or the like executing a computer program, or may be realized as a logic circuit that performs the processing.

The embodiments disclosed herein are to be considered as illustrative and non-limiting in all aspects. The scope of the present disclosure is indicated not by the above-stated meanings but by the claims, and all changes that come within the meaning and range of equivalency of the claims are intended to be embraced therein.

1. An in-vehicle relay apparatus that is to be connected to a plurality of communication lines mounted in a vehicle, and relays transmission/reception of data between the communication lines, the in-vehicle relay apparatus comprising:
a relay restricting unit configured to restrict data that is transmitted by a communication apparatus connected to one communication line from being relayed to another communication line;
a behavior analysis unit configured to analyze an operation performed by the communication apparatus, based on correspondence information between an input value that is input to the communication apparatus and an operation result of the communication apparatus in response to the input value;
an authentication processing unit configured to perform authentication processing on the communication apparatus; and
a restriction cancelling unit configured to cancel relay restriction performed by the relay restricting unit, in accordance with a result of analysis performed by the behavior analysis unit and a result of authentication processing performed by the authentication processing unit.

2. The in-vehicle relay apparatus according to claim 1, further comprising:
a correspondence information obtaining unit configured to obtain the correspondence information from an apparatus external to the vehicle; and
a storage unit configured to store the correspondence information obtained by the correspondence information obtaining unit.

3. An in-vehicle relay apparatus that is to be connected to a plurality of communication lines mounted in a vehicle, and relays transmission/reception of data between the communication lines, the in-vehicle relay apparatus comprising:
a relay restricting unit configured to restrict data that is transmitted by a communication apparatus connected to one communication line from being relayed to another communication line;
a behavior analysis unit configured to analyze an operation performed by the communication apparatus, based on correspondence information between an input test pattern that is input to the communication apparatus and an operation result of the communication apparatus in response to the input test pattern; and
a restriction cancelling unit configured to cancel relay restriction performed by the relay restricting unit, in accordance with a result of analysis performed by the behavior analysis unit,
wherein the correspondence information includes information regarding a plurality of input test patterns that are input to the communication apparatus and a plurality of expected values that are output by the communication apparatus in response to the input test patterns, and
the behavior analysis unit inputs the plurality of input test patterns included in the correspondence information to the communication apparatus in order,
obtains a plurality of output values of the communication apparatus output in response to the plurality of input test patterns in order, and
compares the obtained output values and the expected values included in the correspondence information.

4. (canceled)

5. The in-vehicle relay apparatus according to claim 1, further comprising:
a relay processing unit configured to relay transmission/reception of data related to authentication processing between the communication apparatus connected to the one communication line and the communication apparatus connected to the other communication line, after restriction of relay is canceled by the restriction cancelling unit.

6. An in-vehicle communication system comprising a first in-vehicle relay apparatus mounted in a vehicle, and a plurality of second in-vehicle relay apparatuses connected to the first in-vehicle relay apparatus via first communication lines, the first in-vehicle relay apparatus relaying transmission/reception of data between the plurality of second in-vehicle relay apparatuses, and the second in-vehicle relay apparatuses relaying transmission/reception of data between the first in-vehicle relay apparatus and communication apparatuses connected to the second in-vehicle relay apparatuses via second communication lines,
wherein each second in-vehicle relay apparatus includes:
a relay restricting unit configured to restrict data that is transmitted by a communication apparatus connected to the second communication line from being relayed to the first communication line,
a behavior analysis unit configured to analyze an operation of the communication apparatus based on correspondence information between an input value that is input to the communication apparatus and an operation result of the communication apparatus in response to the input value,
an authentication processing unit configured to perform authentication processing on the communication apparatus, and
a restriction cancelling unit configured to cancel relay restriction performed by the relay restricting unit, in accordance with a result of analysis performed by the behavior analysis unit and a result of authentication processing performed by the authentication processing unit.

7. The in-vehicle communication system according to claim 6,
wherein the second in-vehicle relay apparatus includes a relay processing unit configured to relay transmission/reception of data related to authentication processing between the communication apparatus connected to the second communication line and the first in-vehicle apparatus connected to the first communication line, after restriction of relay is canceled by the restriction cancelling unit, and
the first in-vehicle relay apparatus includes an authentication processing unit configured to perform authentication processing on the communication apparatus connected to the second communication line, via the second in-vehicle relay apparatus.

8. (canceled)

9. A communication method in which an in-vehicle relay apparatus that relays transmission/reception of data between a plurality of communication lines mounted in a vehicle:
restricts data that is transmitted by a communication apparatus connected to one communication line from being relayed to another communication line;
analyzes an operation of the communication apparatus based on correspondence information between an input value that is input to the communication apparatus and an operation result of the communication apparatus in response to the input value;
performs authentication processing on the communication apparatus; and
cancels restriction of relay in accordance with a result of operation analysis and a result of authentication processing.

10. An in-vehicle communication system comprising a first in-vehicle relay apparatus mounted in a vehicle, and a plurality of second in-vehicle relay apparatuses connected to the first in-vehicle relay apparatus via first communication lines, the first in-vehicle relay apparatus relaying transmission/reception of data between the plurality of second in-vehicle relay apparatuses, and the second in-vehicle relay apparatuses relaying transmission/reception of data between the first in-vehicle relay apparatus and communication apparatuses connected to the second in-vehicle relay apparatuses via second communication lines,
wherein each second in-vehicle relay apparatus includes:
a relay restricting unit configured to restrict data that is transmitted by a communication apparatus connected to the second communication line from being relayed to the first communication line,
a behavior analysis unit configured to analyze an operation of the communication apparatus based on correspondence information between an input test pattern that is input to the communication apparatus and an operation result of the communication apparatus in response to the input test pattern, and
a restriction cancelling unit configured to cancel relay restriction performed by the relay restricting unit, in accordance with a result of analysis performed by the behavior analysis unit, and
the correspondence information includes information regarding a plurality of input test patterns that are input to the communication apparatus and a plurality of expected values that are output by the communication apparatus in response to the input test patterns, and
the behavior analysis unit inputs the plurality of input test patterns included in the correspondence information to the communication apparatus in order,
obtains a plurality of output values of the communication apparatus output in response to the plurality of input test patterns in order, and
compares the obtained output values and the expected values included in the correspondence information.

11. A communication method in which an in-vehicle relay apparatus that relays transmission/reception of data between a plurality of communication lines mounted in a vehicle:
restricts data that is transmitted by a communication apparatus connected to one communication line from being relayed to another communication line;
analyzes an operation of the communication apparatus based on correspondence information between an input test pattern that is input to the communication apparatus and an operation result of the communication apparatus in response to the input test pattern; and
cancels restriction of relay in accordance with an analysis result,
wherein the correspondence information includes information regarding a plurality of input test patterns that are input to the communication apparatus and a plurality of expected values that are output by the communication apparatus in response to the input test patterns, and
when the operation is analyzed, the in-vehicle relay apparatus inputs the plurality of input test patterns included in the correspondence information to the communication apparatus in order,
obtains a plurality of output values of the communication apparatus output in response to the plurality of input test patterns in order, and
compares the obtained output values and the expected values included in the correspondence information.
